(19) United States
(12) Patent Application Publication
(10) Pub. No.: US 2008/0158786 A1
(43) Pub. Date: Jul. 3, 2008

(54) Panelboards having support rails

(75) Inventors: William Robert Letourneau, Prospect, CT (US); Thomas Francis Vrnak, Chapel Hill, NC (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: GENERAL ELECTRIC COMPANY

(21) Appl. No.: 11/646,222

(22) Filed: Dec. 27, 2006

(51) Int. Cl. H02B 1/20

(52) U.S. Cl. 361/637

(57) ABSTRACT

A panelboard for a plurality of electrical distribution components with an endplate, main bus bars, and support rails arranged parallel to the main bus bars. The first support rail has a plurality of walls and a plurality of bends that provide support for the first main bus bar. The first support rail has a first flange connected to the endplate and a top flange configured to support the plurality of electrical distribution components.

### BACKGROUND

1. Field

This disclosure relates generally to panelboards and panelboards mounted in switchboards (“panelboards”) for electrical distribution components and, more particularly, the disclosure relates to a support rail for panel boards.

2. Description of the Related Art

Panelboards are used in electrical distribution systems for the mounting of various electrical distribution components. Such components may include protective devices such as switches, circuit breakers, and other components. A protective device is a device that can provide protection against overload such as a circuit breaker, switch or similar device. These electrical distribution components are mounted to a plurality of mounting rails within the enclosure and receive electrical power via buses that extend within the panel board.

Panelboards generally use inner rigid rails to attach a main bus bars and separate outer rails to attach protective devices. The configurations of the outer rails that are used to support the protective devices require additional support brackets. Typically, panelboards will have one or two rows of protective devices mounted within the panel. In such a panelboard an outer rigid rail is needed for each row of protective devices and a separate inner support rail is required for main bus bars that supply power to the protective devices. Unfortunately, the design, construction, and assembly of these prior art panelboards result in high material costs and labor costs.

Accordingly, there is a need for enclosures and panelboards that overcome, alleviate, and/or mitigate one or more of the aforementioned and other deleterious effects of prior art enclosures and panel boards.

### SUMMARY

The present disclosure describes a panelboard for a plurality of electrical distribution components with an endplate, main bus bars, and support rails arranged parallel to the main bus bars. The first support rail has a plurality of walls and a plurality of bends that provide support for the first main bus bar. The first support rail has a first flange connected to the endplate and a top flange configured to support the plurality of electrical distribution components.

The present disclosure further broadly describes a panelboard for a plurality of electrical distribution components with a support rail attached to an endplate. A wire gutter is defined between a horizontal wall on the support rail and a plane parallel with the bottom of the support rail. A main bus bar is attached to the support rail, and the main bus bar is parallel with the support rail and the support rail supports the main bus bar.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of a panelboard implementing an exemplary embodiment of a support rail according to the present disclosure;

FIG. 2 is an elevated side view of the panelboard in FIG. 1;

FIG. 3 is a perspective view of the support rail of FIG. 1;

FIG. 4 is an elevated side view of the support rail shown in FIG. 1; and

FIG. 5 is an exploded perspective view of the panelboard in FIG. 1.

### DETAILED DESCRIPTION OF THE PREFERRED EMBODIMENT

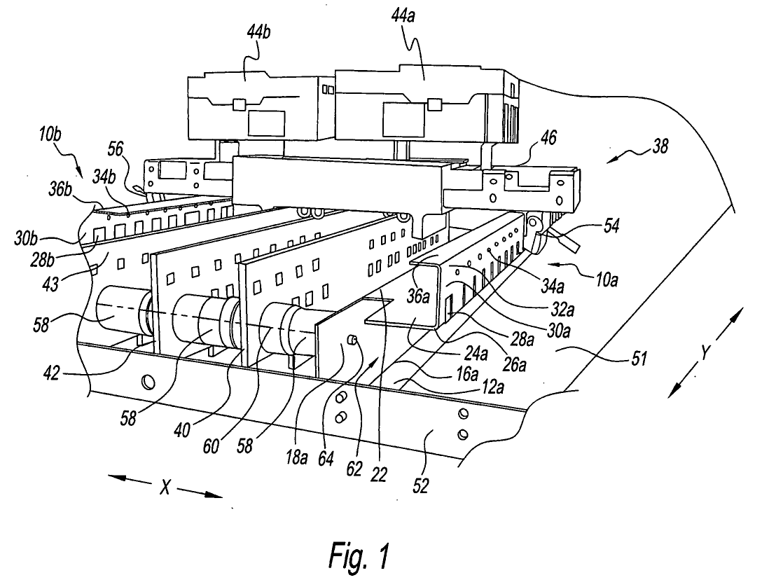

Referring to the drawings, and in particular to FIG. 1, a perspective view of an exemplary embodiment of a support rail 10 according to the present disclosure is shown in use with panel board. Advantageously, rail has several ninety-degree bends that are positioned to enable rail 10 to provide main bus bar support and protective device support concurrently. In this manner, rail 10 is configured to eliminate the multiple support rails of prior art panelboards, while providing a wire gutter space 62 to simplify assembly of the panelboard.

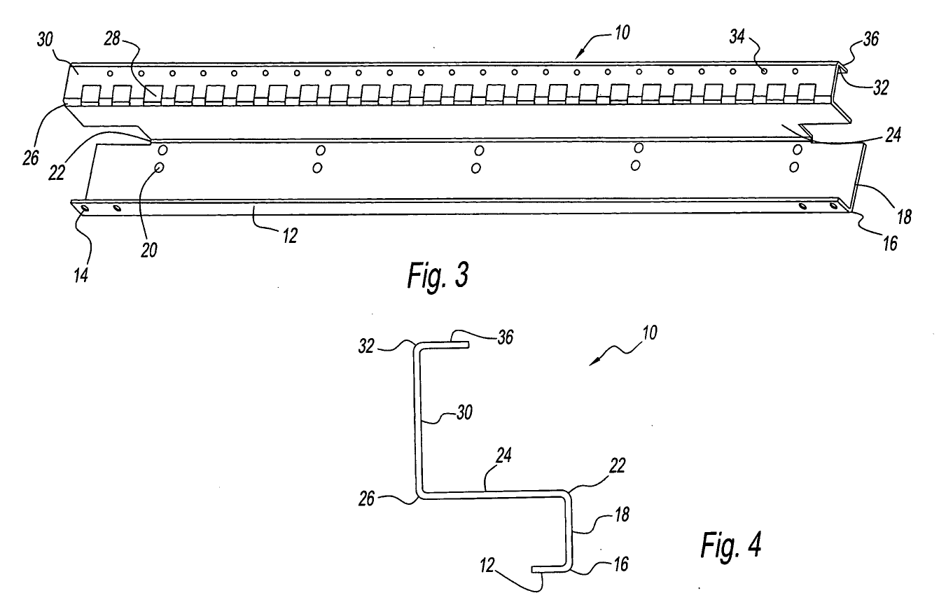

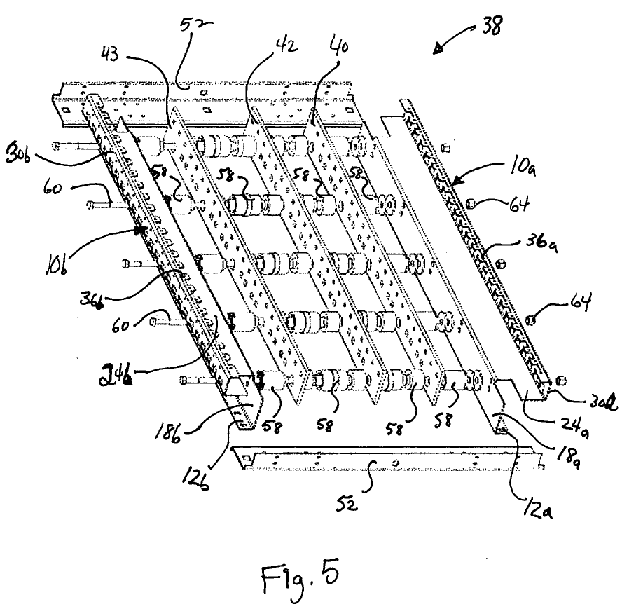

Rail 10 is described by way of simultaneous reference to FIGS. 1 through 5, in particular, FIGS. 3 and 4 focus on the structure of rail 10. Rail 10 has a bottom flange 12 that attaches to an endplate 52. An endplate 52 can be positioned on either side of rail 10 and flange 12 can be secured to endplates 52 on both ends of rail 10. For purposes of the remainder of this disclosure the term panelboard will be used to identify any power supply systems that require main bus bar support, protective device support, and support for similar electrical distribution components.

In some embodiments, bottom flange 12 can have one or more flange-fastening regions 14 for securing rail 10 to endplates 52. In other embodiments, flange-fastening regions 14 can be eliminated and rail 10 can be attached to endplates 52 using a weld or another fastening system known in the art.

Rail 10 can be constructed of sheet metal, such as steel, aluminum, and alloys thereof, that has several apertures and/or slots punched out of the starting work piece. Rail 10 can have several bends applied using a press or other similar device. It should be understood that any material and manufacturing method known in the art could be used as well.

Rail 10 includes a first bend 16 that delineates bottom flange 12 from a first wall 18. In the illustrated embodiment, first bend 16 angles bottom flange 12 roughly ninety degrees from wall 18. Of course, first bend 16 is contemplated by the present disclosure as having any desired angle such as angles larger or smaller than ninety degrees.

First wall 18 provides lateral support for one or more main bus bar 40, 42 that are provided in panelboard 38. In some embodiments, first wall 18 can include one or more wall fastening regions 20, which can be distributed at various points on the first wall. Fastening regions 20 enable main bus bar insulating supports 58 to be attached to first wall 18. In other embodiments, fastening regions 20 can be eliminated and main bus bar supports 58 can be attached to first wall 18 using a weld or another fastening system known in the art. In this manner, rail 10 can supply resistance against lateral movement (e.g., in the x-direction) of main bus bars 40, 42. First wall 18 can be various lengths depending on the application.

Rail 10 also includes a second bend 22 positioned opposite on first wall 18 from first bend 16. Second angle 22 angles first wall 18 roughly ninety degrees from a second wall 24. Second wall 24 can be various lengths depending on the application.

Rail 10 includes a third bend 26 positioned opposite on second wall 24 from second bend 22. Advantageously, first, second, and third bends 16, 22, 26 are sufficient to provide rail 10 with the proper arrangement, once installed in panelboard 38, to enable one or more slots 28 defined in a third wall 30 to function as an attachment position for connecting one or more interface devices 46 to rails 10. Likewise for bolt-on (not shown) device support brackets can be mounted to surface 30.

Slots 28 are positioned in third wall 30 of rail 10 proximate third bend 26 and enable interface devices 46 to attach to the rail. Slots 28 extend from third bend 26 into third wall 30. Third bend 26 angles second wall 24 roughly ninety degrees from third wall 30.

Third wall 30 extends from third bend 26 to a fourth bend 32. Third wall 30 can also have one or more apertures 34 positioned at various points on the third wall to enable the attachment of brackets 54, 56, for one or interface devices 46, to rail 10. Applying additional apertures or slots to third wall 30, such as apertures 34, are dependent on the type of protective device interface that is used. Thus, the implementation of apertures and slots on third wall 30 can be varied from the structures that are described in this disclosure.

Fourth bend 32 defines one end of a top flange 36. In the illustrated embodiment, fourth bend 32 angles third wall 30 roughly ninety degrees from top flange 36. In this manner, top and bottom flanges 12, 36, are roughly parallel to each other. Additionally, first and second walls 18, 30 are intended to be roughly parallel to each other as well. Divergence from these arrangements is considered within the spirit and scope of the disclosure, however, as the flanges and walls of rail 10 can be positioned at angles other than ninety degrees.

FIG. 3 shows an elevated side view of rail 10. From this view the positioning of the four bends 16, 22, 26 and 32, and their relationship with flange 12, wall 18, ledge 24, third wall 30 and flange 36, is readily apparent. The general s-shaped profile of rail 10 is also apparent. This arrangement, although an exemplary embodiment of the present disclosure, can be altered to have different surface lengths and angles, providing a different profile.

As shown in FIG. 1, rail 10 is intended for implementation in panelboard 38 to provide concurrent support for main bus bars 40 and 42 and protective devices 44. In the illustrated embodiment, panelboard 38 includes a pair of rails 10 disposed at opposite sides of the panelboard. In the illustrated embodiment, rails 10 are oriented facing to one another. However, it is also contemplated that rails 10 are oriented identically to one another.

Main bus bars 40 and 42 are electricity distribution components shown as vertical bus bars that are perpendicular to a surface 12 of rail 10. It should be noted that main bus bars 40 and 42 could also be positioned in another manner.

Protective device 44a is attached to interface device 46, and protection device 44b is attached to interface device 46. Interface device 46 is in electrical communication with main bus 40 at a contact C1, and is attached to rail 10a with a bracket 54 on one end of interface device 46. Similarly, interface device 46 is in electrical communication with main bus 42 at a contact C2, and is attached to rail 10b with a bracket 56 at the opposite end of interface device 46. As shown interface 46 rests on flange 36, so that brackets 54 and 56 are fastened to slot 28a and 28b, and/or possibly apertures 34a and 34b, respectively. Protective devices 44a, 44b are attached to interface device 46, so that the protective devices 44 interact with main bus bars 40 and 42, respectively, in a known manner.

Panelboard 38 is illustrated by way of example having two rails, rails 10a and 10b, and two or three main buses 40, 42 and 43 where each rail allows a row of protective devices 44 to be secured thereto. For example, if a panel board has two rows of protective devices, interface 46 would attach to rail 10a on one side of panelboard 38, and interface 46 will attach to the rail 10b on the other side of panelboard 38. In an arrangement of this type, as shown in FIG. 1, interface devices 46 will interact with two or three separate main bus bars 40, 42 and 43, respectively.

Rail 10 attaches to an inside surface of endplate 52 of panelboard 38. More particularly, flange 12 can be secured to endplate 52 in any known manner in the art. Flange 12 is positioned parallel with a plane that is perpendicular to main bus bars 40, 42 and 43 in panelboard 38.

Advantageously, the four bends 16, 22, 26, 32 in rail 10 enable it to remain stable with only flange 12 attached to endplate 52. The positioning of bends 16, 22, 26 and 32 enable the forces exerted on rail 10 to be distributed in a manner that reduces stress that would normally require bracing or bracketing for rails in conventional panelboards. Generally, rail 10 would have support insulators 58 along the length of rail 10 between the rail and main bus bars.

The deflection of rail 10 between support insulators 58 is decreased compared to rails used in traditional panelboards. Existing panelboards use two rails to support main bus bars and a protective device and the two separate rails are configured to have no more than three bends combined. Thus, the rail that supports a main bus bar in a conventional panelboard has a single bend and is subject to substantial deflection, i.e., conventional rails are structurally inferior to single rail 10. The decreased deflection between insulators 58 is derived directly from the four bends, specifically, bends 16, 22, 26 and 32, and the five surfaces, specifically, flanges 12, 36 and walls 18, 24, 30.

Rail 10 provides lateral support for main bus bars 40, 42 and 43. Forces acting upon main bus bars 40, 42 and 43 attempt to push the main bus bars 40, 42 and 43 toward or away from each other along the x-axis. Positioning wall 18, on rail 10, proximate main bus bars 40 and 42, stabilizes lateral movement. Insulators 58 are positioned between the outside planar surface of main bus bar 40 and first wall 18.

A threaded rod or similar component 60 (shown in phantom) can be used to attach rail 10a on one side of panel to rail 10b on the opposite side of the panel. Threaded rod 60 runs through the center of insulators 58, through apertures 20 in rails 10 and though apertures (not shown) in main bus bars 40, 42 and 43. This arrangement sandwiches main bus bars 40, 42 and 43, and insulators 58 between rails 10, which provides the lateral support needed to resist forces pushing and pulling main bus bars 40, 42 and 43 along the x-axis. Threaded nuts 64 or a similar attachment means can be used to secure threaded rod 60 in place.

Connecting first wall 18 to main bus bar 40 also strengthens the capability of main bus bars 40, 42 and 43 to resists forces along the y-axis. Multiple insulators 58 and connections between rail 10a and main bus bar 40, and rail 10b and main bus bar 42 can be used along the length of main bus bars 40 and 42 and rails 10 to increase stability.

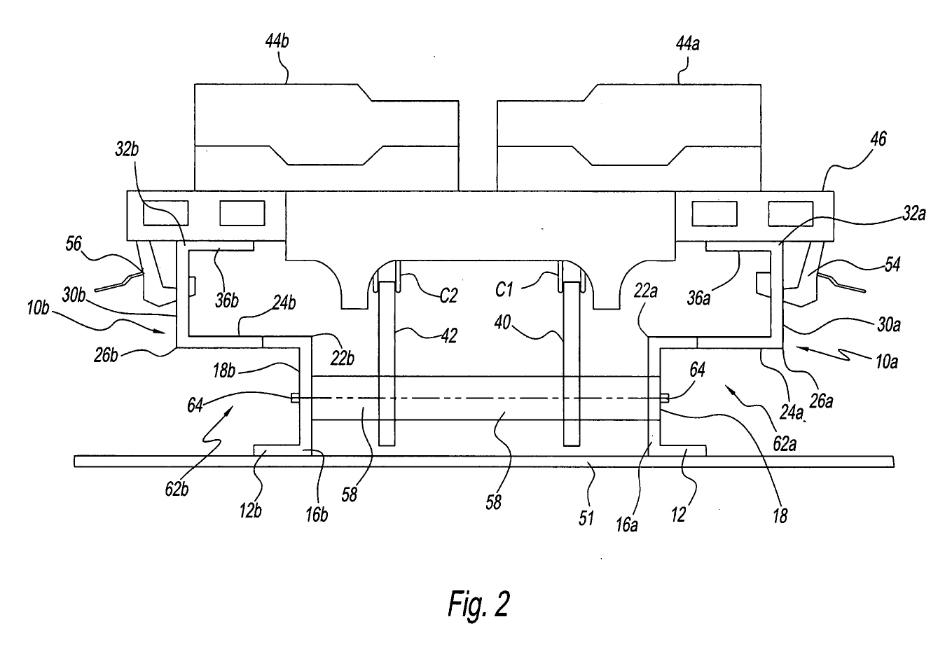

FIG. 2 shows an elevated side view of panel board 38. Rail 10b is shown attached to endplate 52 opposite rail 10a. Two separate rails 10a and 10b are shown to demonstrate that multiple rails can be used on panelboard 38. Rails 10a, 10b can be attached to endplates 52 in parallel using an attachment system known in the art. The structure of rails 10a and 10b is similar to the extent that rail 10b is a mirror image of rail 10a. Rail 10b has bends 16b, 22b, 26b, and 32b positioned to provide flange 12b, first wall 18b, second wall 24b, third wall 30b, and flange 36b. In particular, first wall 18b, second wall 24b, third wall 30b, and flanges 12b and 36b on rail 10b are mirror images of their counterpart walls and flanges on rail 10a. The construction and positioning of the bends and walls of rail 10b mirror that of the bends and walls in rail 10a.

In addition, rails 10 advantageously define a wire gutter 62, which is a space formed under second wall 24. Second wall 24 is a horizontal wall and wire gutter 62 is defined under second wall 24 and a plane parallel with a bottom flange 12 of rail 10. Surface 51 defines a plane parallel with bottom flange 12.

In FIG. 2, rails 10a and 10b each have wire gutters 62a, 62b defined under horizontal walls 24a, 24b, and above surface 51, i.e., between the plane parallel with flanges 12a, 12b and walls 24a, 24b. Gutter 62 has been found by the present disclosure to provide additional space for running wiring (not shown) to protective devices 44.

Traditional rail support afforded very little room to run wiring, which increased installation time for a panelboard. Gutter 62 enables an installer of panelboard 38 to neatly position wires feeding protective devices 44. Gutter 62 also increases the room for storing wiring increasing the ease of panelboard installation, and reducing the time needed to complete an installation.

FIG. 5 is an exploded perspective view of panelboard 38 showing the positioning of rails 10a and 10b on the outside of main bus bars 40, 42 and 43 in an exemplary embodiment of the disclosure. Endplates 52a and 52b are attached to opposite ends of rails 10a and 10b.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A panelboard for a plurality of electrical distribution components, comprising:
an endplate;
a first main bus bar; and
a first support rail arranged parallel to said main bus bar, said first support rail having a plurality of walls and a plurality of bends that provide support for said first main bus bar, said first support rail having a first flange connected to said endplate and a top flange configured to support the plurality of electrical distribution components.

2. The panelboard of claim 1, wherein said first support rail defines a wire gutter between said endplate and one of said plurality of walls.

3. The panelboard of claim 1, wherein said first main bus bar is vertically oriented and perpendicular to said endplate.

4. The panelboard of claim 1, further comprising an interface with a bracket, said bracket being supported by said top flange and said interface being configured to received at least one of the plurality of electrical distribution components.

5. The panelboard of claim 1, wherein said first support rail is s-shaped.

6. The panelboard of claim 1, further comprising an insulating support that is disposed between said first support rail and said first main bus bar, wherein said insulating support is perpendicular to said first support rail and said first main bus bar.

7. The panelboard of claim 1, further comprising:
a second main bus bar arranged parallel to said first main bus bar; and
a second support rail attached to said endplate and arranged parallel to said second main bus bar.

8. The panelboard of claim 7, wherein said second support rail has a plurality of walls and a plurality of bends that provide support for said second main bus bar, said first support rail having a first flange connected to said endplate and a top flange configured to support the plurality of electrical distribution components.

9. The panelboard of claim 7, wherein said second main bus bar is vertically oriented and perpendicular to said endplate.

10. The panelboard of claim 1, wherein said second support rail defines a wire gutter between said endplate and one of said plurality of walls.

11. A panelboard for a plurality of electrical distribution components, comprising:
an endplate;
a support rail attached to said endplate so that a wire gutter is defined under a horizontal wall on said support rail and a plane parallel with the bottom of said support rail; and
a main bus bar attached to said support rail, wherein said main bus bar is parallel with said support rail and said main bus bar is supported by said support rail.

12. The panelboard of claim 11, wherein said support rail comprises a top flange for supporting the plurality of electrical distribution components.

13. The panelboard of claim 11, further comprising an insulator support arranged between said support rail and said main bus bar.

14. The panelboard of claim 11, wherein said support rail provides lateral support to said main bus bar.

15. The panelboard of claim 11, wherein said support rail has a first wall attached to a second wall, wherein said first wall is attached to said main bus bar and provides support to said main bus bar, and said second wall is positioned above said wire gutter.

16. A panelboard for a plurality of electrical distribution components, comprising:
an endplate; and
a support rail having a bottom flange, a first bend, a first wall, second bend, a second wall, a third bend, a third wall, a fourth bend, and a top flange, said bottom flange being attached to said endplate, and said top flange being configured to receive plurality of electrical distribution components.

17. The panelboard of claim 16, wherein said bottom flange, said first and second bends, and said first and second walls define a wire gutter between said support rail and a plane parallel with said bottom flange.

18. The panelboard as in claim 16, further comprising a main bus bar attached to said support rail by an insulating support, said main bus bar being parallel to and supported by said support rail.

19. The panelboard of claim 16, wherein said first, second, third, and fourth bends are each approximately ninety degrees such that said first, second, and third walls are parallel to one another and said top and bottom flanges are parallel to one another.
